(19) United States
(12) Patent Application Publication
(10) Pub. No.: US 2010/0163316 A1
(43) Pub. Date: Jul. 1, 2010

(54) Handwriting Recognition System Using Multiple Path Recognition Framework

(75) Inventors: Ming Chang, Beijing (CN); Shi Han, Beijing (CN); Dongmei Zhang, Redmond, WA (US); Yu Zou, Beijing (CN); Xinjian Chen, Beijing (CN)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/345,668

(22) Filed: Dec. 30, 2008

(51) Int. Cl. G08C 21/00

(52) U.S. Cl. 178/18.01

(57) ABSTRACT

Described is a multi-path handwriting recognition framework based upon stroke segmentation, symbol recognition, two-dimensional structure analysis and semantic structure analysis. Electronic pen input corresponding to handwritten input (e.g., a chemical expression) is recognized and output via a data structure, which may include multiple recognition candidates. A recognition framework performs stroke segmentation and symbol recognition on the input, and analyzes the structure of the input to output the data structure corresponding to recognition results. For chemical expressions, the structural analysis may perform a conditional sub-expression analysis for inorganic expressions, or organic bond detection, connection relationship analysis, organic atom determination and/or conditional sub-expression analysis for organic expressions. The structural analysis also performs subscript, superscript analysis and character determination. Further analysis may be performed, e.g., chemical valence analysis and/or semantic structure analysis.

### BACKGROUND

Handwriting recognition is a useful tool, particularly when other forms of input such as keyboard and mouse do not match well with the type of information being input. For example, when computer users in the field of chemistry use a personal computer to write chemical literature, the input of chemical expressions is a frequent task. At present it is very inconvenient and difficult to input a chemical expression using a keyboard or mouse. This is true in general, but is particularly problematic for organic chemical expressions.

Pen input is a more convenient and natural method for chemical expressions. Heretofore, however, handwritten chemical expression recognition of pen-based input has not been very successful.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which electronic pen input corresponding to handwritten input is recognized into an output data structure. The output data may include data for multiple recognition candidates.

In one aspect, the input comprises handwritten electronic input with a two-dimensional structure. A framework performs stroke segmentation and symbol recognition on the input, analyzes the two-dimensional structure of the input, and outputs a data structure corresponding to recognition results of the handwritten input. Analyzing the two-dimensional structure of the input may include performing a conditional sub-expression analysis, performing a subscript, superscript analysis and a character determination analysis and/or performing a semantic structure analysis. Performing the semantic structure analysis may include performing a syntax analysis with a syntax tree,

In one aspect, when the handwritten input includes an organic chemical expression, analyzing the two-dimensional structure of the input comprises performing a bond detection and connection relationship analysis, and/or performing atom determination. Performing the semantic structure analysis may comprises performing a chemical valence analysis.

In one aspect, the data structure comprises a baseline structure tree. When recognition results in a plurality of recognition candidates, the data structure may include a plurality of solution nodes, each solution node corresponding to a recognition candidate. The data structure with solution nodes may be an extended baseline structure tree.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram showing example components of an example handwritten recognition system.

FIG. 2 is an example of a chemical expression that may be input into the system.

FIG. 3 is a flow diagram showing components and/or steps of the recognition system.

FIG. 4 is an example of a chemical organic expression that may be input into the system.

FIG. 5 is an example of a chemical inorganic expression that may be input into the system.

FIG. 6 is a representation of a multi-path solution for handwriting recognition, using chemical expression as an example.

FIG. 7 is a data structure (a baseline structure tree) corresponding to the expression of FIG. 5.

FIG. 8 is a representation of a solution node useful for extending the data structure of FIG. 7.

FIG. 9 is a data structure corresponding to part of the expression of the organic molecule representation of FIG. 4.

FIG. 10 is a representation of corner point's detection.

FIG. 11 shows quantified four directions for various kinds of bonds.

FIG. 12 is a representation of the reference atoms index in a bond.

FIG. 13 is a representation of the control region of a chemical bond.

FIGS. 14 and 15 are examples of chemical inorganic expressions that may be input into the system.

FIG. 16 shows an illustrative example of a computing environment into which various aspects of the present invention may be incorporated.

### DETAILED DESCRIPTION

Various aspects of the technology described herein are generally directed towards a recognition system for pen-based (that is, electronically handwritten) recognition, which can output multiple candidates. The technology may be applied to chemical expression recognition. For example, organic chemical expressions and inorganic chemical expressions are recognized, which may be individually accomplished by separate recognizers or logic that handles both.

It should be understood that any of the examples described herein are non-limiting examples. Indeed, while the examples used are chemistry expression recognition examples, the described recognizer may be used to solve any handwritten recognition problem, e.g., with a two-dimensional structure for a specific symbol set. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing and handwriting recognition in general.

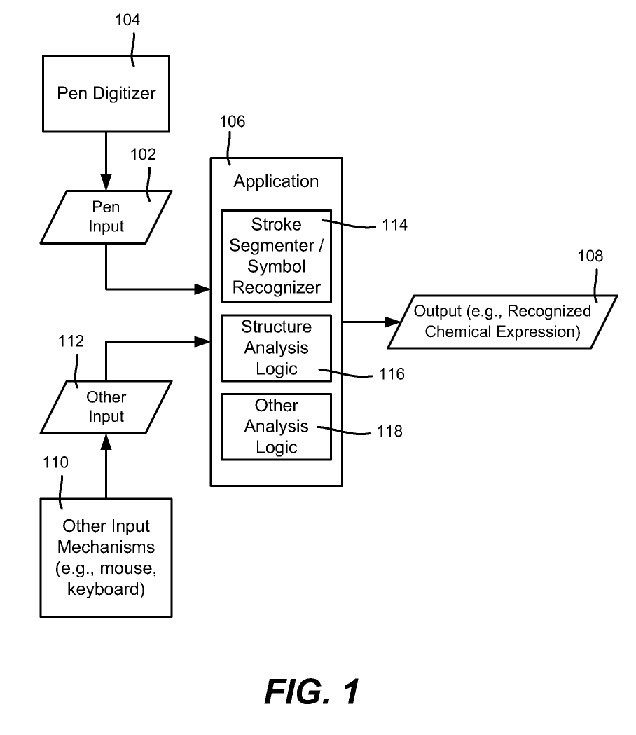

FIG. 1 shows various aspects related to a handwriting recognition system. In general, a user provides pen input 102 via an electronic digitizer 104, e.g., via a pad or touch-screen device, to an application 106 that processes the input into output 108, e.g., a data structure or the like that can be edited, saved, visually represented, and so forth. Other optional input mechanisms 110 and corresponding input 112 may be used to control the application, e.g., to switch modes, type in text, and so forth.

While FIG. 1 shows the recognition system as based upon a separate application, it is understood that this is only an example. An alternative is for a word processor or other suitable program to incorporate the recognition system as a module or the like therein. Further, while the components of the application are shown as part of the application, it is understood that these may be external modules or the like called by the application, e.g., the application may send input data to an external recognizer and receive recognition results.

The exemplified application 106 of FIG. 1 includes a stroke segmenter/symbol recognizer 114, which may be any of known technologies, private technologies, or technologies not yet developed. Also exemplified is structure analysis logic 116 and other analysis logic 118 (e.g., electronic balance, chemical valence analysis and/or semantic structure analysis) as exemplified below.

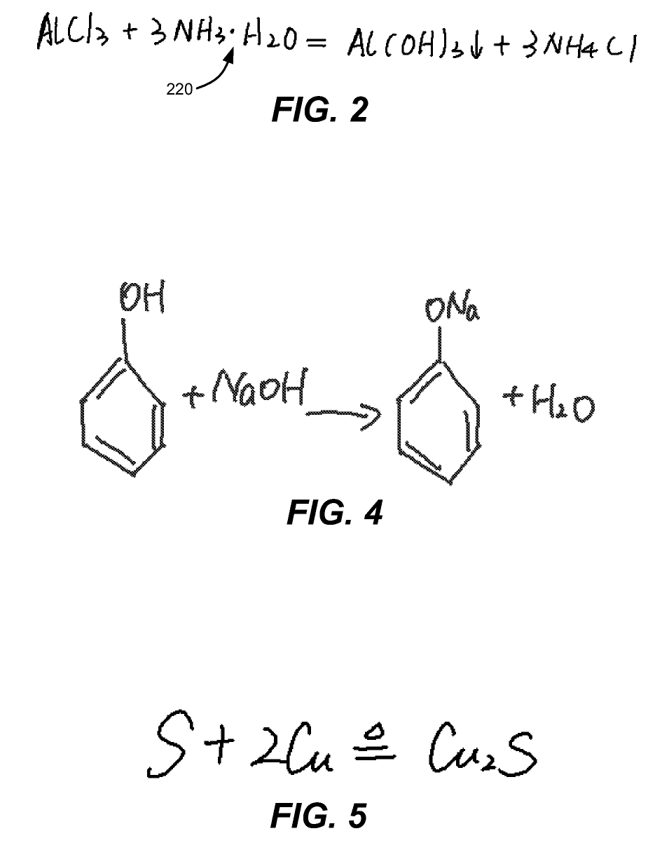

In general, unlike printed expressions, ambiguities exist in handwriting input, such as when inputting handwritten chemical expressions. For example, it is difficult to distinguish certain symbols from others using only shape information. Consider a ‘dot’—when a dot is a subscript position, it is a decimal dot, but when at a more level position, it is a chemical connection operator, as shown by the dot symbol 220 in FIG. 2. As another example, there are often many uncertainties in layout structure, e.g., sometimes, an activator molecule may expand outside of a condition line, because there is not enough room above the line.

To deal with the ambiguities, one implementation of the recognition system uses a multi-path framework. The multi-path framework utilizes multi-path algorithms and outputs multiple results via several components, including symbol grouping and symbol recognition, conditional sub-expression analysis, and subscript, superscript analysis and character determination. The system can output multiple recognition candidates for each handwritten expression by combining multiple results from the components. This significantly reduces problems caused by ambiguities.

In order to evaluate a handwritten chemical expression recognition system, a database containing labeled handwritten chemical equations is used. Unlike traditional systems that manually label symbols and structures for each chemical equation, which is time consuming and error prone, a semi-automatic approach to label the handwriting chemical equations may be used, which makes chemical expression labeling significantly more convenient and efficient.

A number of terms are used herein, and are generally defined as follows. A stroke refers to the trajectory of a pen tip between pen down and pen up positions. Usually, a stroke is described by a series of points with timestamps, such as a series of (x, y, time) values. A symbol comprises one or multiple strokes, in which the symbol is a handwritten version of pre-defined chemical characters including chemical elements, digits, and so forth. An expression is a meaningful combination of chemical symbols. A molecule is a combination of chemical symbols, which as used herein, refers to organic expressions. A character is the corresponding computer code of a handwritten symbol; symbol recognition thus takes a symbol's strokes as input, and outputs the symbol's corresponding character. Note that symbol recognition can provide a single character, or a list of character candidates for each symbol.

Other terms include a sub-expression, which is a meaningful subpart of an expression. A sub-expression is an expression itself. One kind of sub-expression includes a subordinate sub-expression, which is a sub-expression subordinate to a dominant symbol. Another kind is subscript and superscript sub-expression, each of which is a sub-expression that is a subscript or superscript of another symbol, respectively.

A dominant symbol is a chemical symbol that may be attached to by its subordinate sub-expressions; the spatial relationships between dominant symbols and its sub-expressions are variant to the dominant symbols' types. An expression often has several sub-expressions, which forms a tree structure according to their relationships of principal and subordinate.

A BST tree (baseline structure tree) is a data structure for representing an expression. In the representation, an expression is a tree, whose levels are baselines (where baseline means that symbols within a baseline are located in a horizontal line; as used herein, baseline is a synonym of sub-expression).

A parse tree is an extended version of a BST tree. A parse tree can store multiple results for key components of the system, and support the functionality of providing multiple recognized candidates for a handwritten expression. In one implementation, a parse tree is passed from component to component. Each component receives a parse tree partially processed by a previous component, performs its job, writes its results back to the parse tree, and passes the parse tree to next component.

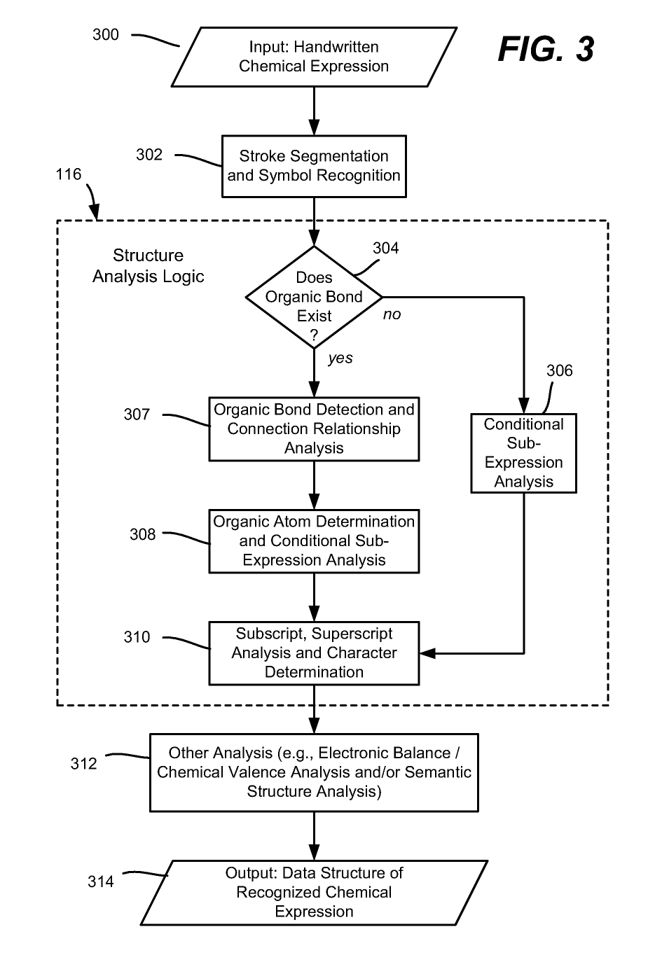

FIG. 3 is a flow diagram showing example steps/components in a multi-path framework for handwritten chemical expression recognition of input (step 300); the steps generally correspond to the logic of FIG. 1. Step 302 represents symbol segmentation (grouping) and symbol recognition, which in general groups strokes into symbols, and recognizes the symbols independently. In one implementation, the output is a set of possible character candidates with corresponding confidence values for each symbol.

Step 304 represents organic atom determination. If not organic, conditional sub-expression analysis is performed at step 306 as described below, otherwise steps 307 and 308 perform organic bond detection and connection relationship analysis and organic atom determination and conditional sub-expression analysis, respectively, as also described below. Step 310 represents subscript and superscript analysis, and character determination. Chemical valence/electronic balance analysis and semantic structure analysis are represented by step 312. The data structure output is represented by block 314. Note that symbol grouping and recognition, organic atom determination and conditional sub-expression analysis, subscript, superscript analysis and character determination components may output multiple results.

With respect to the structure analysis logic 116, compared to plain text, chemical expression has a more complex structured layout, especially for organic expression. Expressions have their unique structures. For example, a condition symbol (‘→’) has two attached sub-expressions, namely above and below sub-expressions, to express condition lists (activator, reaction condition notation (Δ), and so forth). In general, the structure analysis logic 116 discovers the structural information, which in one implementation is performed by the conditional sub-expression analysis step/component 306, or the organic bond detection step/component 307 and the organic atom determination step/component 308, along with the subscript, superscript analysis and character determination step/component 310.

In a chemical expression, a condition symbol (‘=’, ‘→’, ‘ [symbol] ’) may have two attached sub-expressions, which are above and below sub-expressions to express condition lists (activator, reaction condition notation (Δ), and so forth. In the system, conditional sub-expression analysis step/component 306 finds the sub-expressions for each conditional symbol.

For the organic bond detection and connection relationship analysis (step 307), unlike chemical inorganic expression, the chemical organic expression contains a more complex structure formed by chemical bonds. FIG. 4 shows an example of a chemical organic expression. The connection structure between chemical bonds constructs a graph. This component detects organic bonds in the expression, and analyzes the connection relationship between the organic bonds, as described in more detail below.

With respect to organic atom determination and conditional sub-expression analysis (step 308), for chemical organic expressions, some atoms may exist that are connected to chemical bond, as in the example of FIG. 4. This step/component 308 detects the attached atoms for each chemical bond.

The subscript, superscript analysis and character determination step/component 310 finds subscript and superscript structures and decides each symbol's final character. In one implementation, this is performed at the same time.

Step 312 represents the chemical valence analysis and semantic structure analysis. More particularly, each chemical element has its own chemical valence. The molecule in the expression is composed of chemical elements. For every molecule, the chemical valence is balanced. Based on this point, the chemical valence analysis is processed to validate each molecule. Chemical valence analysis and semantic structure analysis are described below with reference to chemical inorganic expression recognition.

During the above-described processing, a tree structure of sub-expressions is built up, and every character is decided. This information is sufficient to recognize a handwritten expression. However, the semantic structure is not discovered in its sub-expressions.

In order to convert the recognized expression to a semantic structure, text strings translated from sub-expressions are parsed by syntax analysis, and transformed into a syntax tree. This step/component 312 revises the parse tree according to the results of syntax analysis, which is the final parse tree, referred to as the semantic tree of the expression.

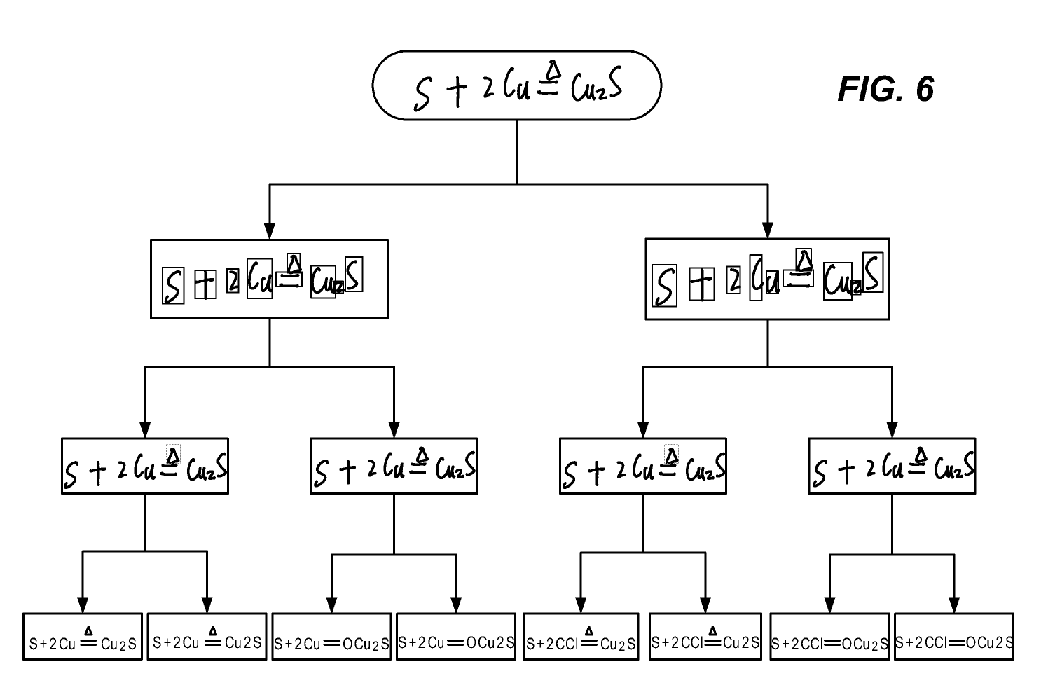

To exemplify the aspects of multi-path framework, FIG. 5 is used as an example, which when processed by the steps/components of FIG. 3, results in the representation of FIG. 6. The input handwritten expression of FIG. 5 is a sequence of strokes. After stroke segmentation, two ways for segmentation are identified. A first way groups the strokes into the chemical element ‘Cu’. The second way separates the strokes into a chemical element ‘C’ and another element ‘Cl’. In this example, the other symbols are the same in either of the two ways.

As there are no chemical bonds detected, the structure analysis logic 116 branches to perform the conditional sub-expression analysis part (step 306). After subordinate sub-expression analysis, following each of the two segmentation ways, there are also two feasible results for this step. One result is the symbol “Δ” is positioned above the chemical condition symbol “=”. The other is that is the symbol “Δ” has no above-positioning relationship with the chemical condition symbol “=”.

When the subscript, superscript analysis and character determination step of 312 is finished, there are also two possible results for the molecule “Cu2S” which are “Cu₂S”, (“Cu<sub>2</Sub>S”) and “Cu2S”. In the other case, the results are similar. Thus, the system gets eight reasonable candidates given such a relatively simple expression.

Turning to the data structures used to support the multi-path framework, a data structure stores the multiple candidate results obtained by the multi-path algorithms. The structure is passed from the first component/step to the last component, as described above, e.g., each component gets the structure from the previous component, does its analysis, writes its results back into the structure and passes the structure to next component. Thus, after recognition is done, the system gets such a data structure comprising multiple results from many components. With the data structure, the candidates of an entire expression may be obtained by selecting a result for each multi-path component, e.g., sequentially. Moreover, the system may get multiple expression candidates with different selections, and rank them by a combined score, comprising scores of components.

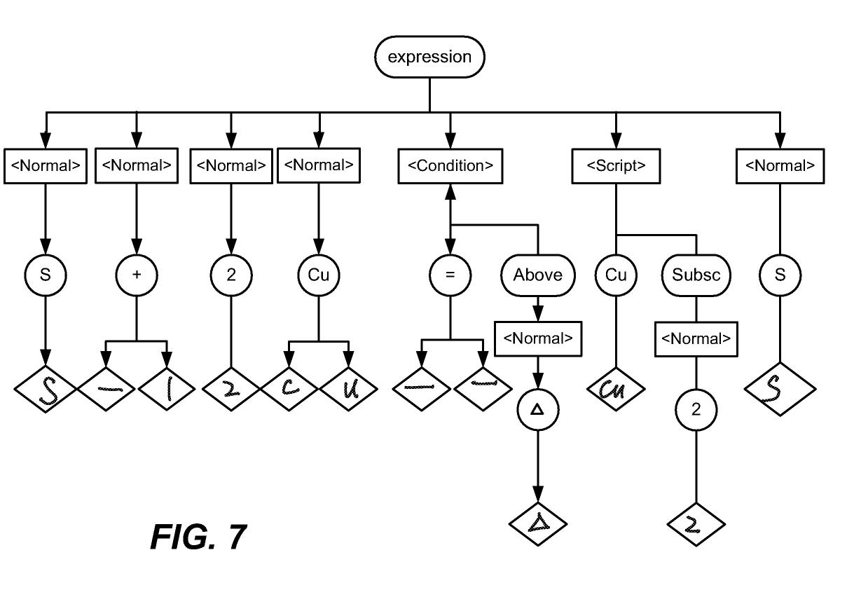

In one implementation, the data structure representing a single structured expression is a baseline structure tree (BST), as shown in the example of FIG. 7. The general idea of a BST is to view an expression as a tree composed of multiple-level baselines. Within a baseline, symbols are horizontal neighbors. In a layout, the symbols lie in a horizontal line.

The example BST tree structure of FIG. 7 has three levels of baselines, including a first baseline “S+2Cu=CuS” as the main baseline. The second baseline “Δ” is a sub-expression subordinate to the condition symbol “=”. The third baseline “2” is a subscript of “Cu” which is at the second baseline.

In the inner data structure of the example, four types of tree nodes are defined to represent BST tree in the system. A stroke node (a diamond in FIG. 7) represents a stroke in ink expressions. It stores the (x, y) position of each point of a stroke and a timestamp of when the pen tip was down. A symbol node (a circle in FIG. 7) represents a symbol, which may comprise several strokes. A symbol node records the references to its child strokes; its child nodes need to be stroke nodes. A symbol node also stores a symbol's character candidates and confidences obtained from the symbol recognition.

A BST symbol node (a rectangle in FIG. 7) is a middle-level node between a symbol node and a relation node, and a BST symbol node is child node of a relation node. A BST symbol node may have a symbol node and a relation node as its child nodes. A BST symbol node is designed to represent a compound of a dominant symbol and its sub-baselines (sub-expressions). However, a single symbol, which has no sub-baselines (sub-expressions), is wrapped into a BST symbol node with a tag “normal”, in order to become a child of a relation node. Tags defined for BST symbol node include:
Normal: a symbol without subordinates;
Decorated: a symbol with a subscript or superscript;
Condition: a condition line with subordinate expression (above or below relationship);
Bond: a chemical bond;
Atom: a chemical atom connected with a chemical bond;
Molecule: a combination of chemical symbols, herein referred to as an organic molecule.

A relation node (a rounded rectangle in FIG. 7) represents a baseline (sub-expression), comprising several BST symbol nodes located in a horizontal line. Its children are BST symbol nodes. The following tags are defined for a relation node:
Above: a sub-expression above a condition line.
Below: a sub-expression below a condition line.
AtomArray: a combination of atoms in organic expression.
BondArray: a combination of bonds in organic expression.
Superscript: a superscript sub-expression
Subscript: a subscript sub-expression
Expression: the main (top-level) sub-expression.

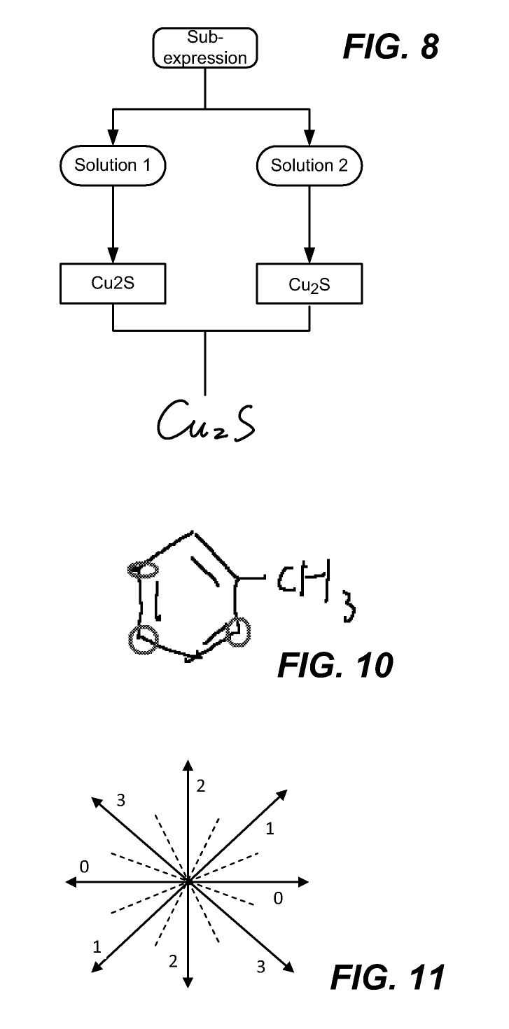

The structure with multiple results is an extended BST tree. In addition to the above-described four types of nodes, a new type node, referred to as a solution node, is incorporated into the system to represent various results for the same object. FIG. 8 shows two solution nodes used to represent two interpretations of strokes, namely the first solution means “Cu2S”, the second one means “Cu<sub>2</sub>S” (Cu₂S).

As shown in FIG. 8, the two solutions refer to the same strokes. Note that in other implementations, it is necessary to have these multiple references to the same objects, however, because multiple results may be found in the various components, always duplicating a tree or a sub-tree for each of these results will require a relatively huge amount of memory due to exponential combinations. Moreover, the idea of simple duplication also results in unnecessary repeated calculations. Instead, the new type of (solution) node and with the design of multiple references, the extended BST tree data structure efficiently stores multiple results obtained by the components. In one implementation, the extended BST tree is parsed component by component, and thus as defined above, in many contexts, the extended BST tree is called a parse tree.

### Handwritten Organic Chemical Expression Recognition

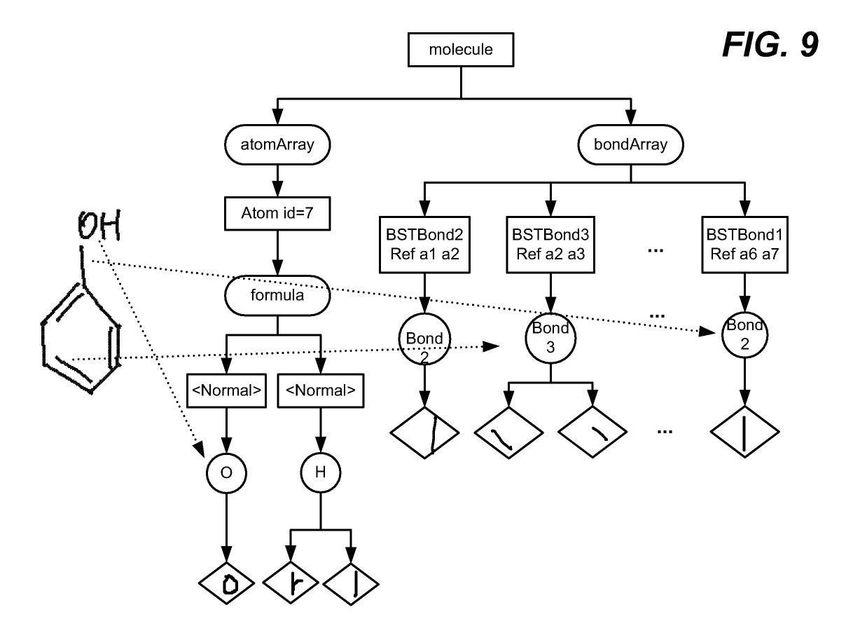

As described above, chemical organic expression is performed in the recognition system's framework. With respect to chemical organic bond detection and connection relationship analysis, chemical atoms are defined as the combination of chemical atom connected to chemical bond (actually it is an ion). FIG. 9 shows an organic molecule and its data structure. In this example, “OH” represents atoms. For each atom, there is an atoms Index, that is, indexed by its number.

A chemical bond is the physical process responsible for the attractive interactions between atoms and molecules, and that which confers stability to diatomic and polyatomic chemical compounds. As used herein a bond represents the connection line between the atoms as in FIG. 9. In one system, chemical bonds are classified into one of three kinds, namely single bond represented by a single horizontal line, a double bond represented by two horizontal lines, and triple bond represented by three horizontal lines.

Each type of bond has a direction property, which in one system is represented by the direction of the connection line. Each type of bond also has a two reference atoms index property, that is, the two connected chemical atoms indexed by the chemical bond.

For bond detection and relation analysis, it is noted that when people write the chemical bonds, especially for a benzene ring, most attempt to write some connected bonds in one stroke as in the example of FIG. 10. In order to analyze the relationship between atoms, the system splits the stroke into the bonds according to the following for splitting a stroke:
1. Detect the corner points for every stroke; (note that there are many well-known methods for detecting corner points in a curve, and any one may be used).
2. For each fragment, judge whether it is a line, e.g., by calculating the coherence of the point's curvature. If the coherence is less than predefined threshold, the fragment is considered to be a line; otherwise it is not a line.
3. If all the fragments are lines, and each length is above a pre-defined length threshold, the stroke is considered as connected chemical bonds, and is segmented by the corner points; otherwise, the stroke will not be considered as chemical bonds, and it is not segmented.

In one system, a chemical bond is classified into a single bond, a double bond or a triple bond. For each kind of bond, there are many possible directions, but may be quantified to a limited number n of directions (e.g., n=4) as shown in FIG. 11. For example, as shown in FIG. 9, the direction of the bond connected with atoms “OH” is quantified as two. There are thus twelve (3*4) kinds of chemical bonds.

Note that for every bond, many training samples were collected. The recognition method used in “stroke segmentation and symbol recognition” component was used to recognize the chemical bond. After recognition, if a symbol was considered as a chemical bond, the context is introduced to validate it. For example, if there is a symbol “Δ” above it, it is considered as not a chemical bond, but a chemical condition symbol.

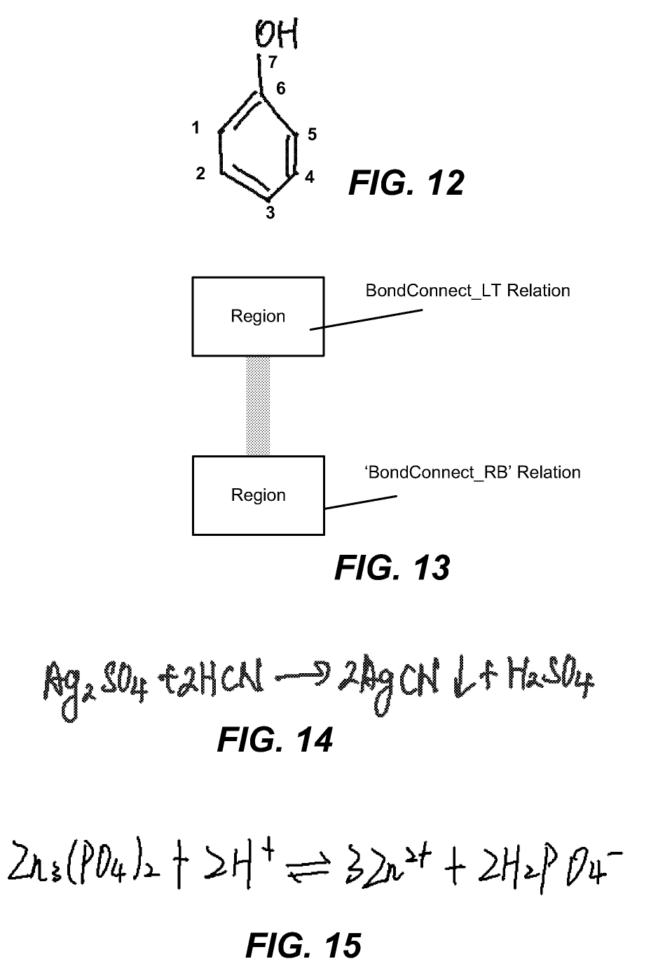

After detecting the chemical bond, the bond connection relationship analysis is processed. Each bond has two anchor points, namely a starting point and ending point. The distance between the anchor points in the two different bonds is computed. If the distance is less than the threshold, the two bonds are considered as connected, otherwise, not connected. The connected bonds share the same index for their connected anchor point. FIG. 12 shows the bond connection relationship analysis result of the example of FIG. 9.

With respect to organic atom determination and conditional sub-expression analysis, as mentioned above, for some chemical bonds in an expression, there may be atoms connected to them, and the condition symbol (‘→’) may have two attached sub-expressions, that is, above and below sub-expressions to express condition lists. These symbols are referred to as dominant symbols, which imply particular layout types in expressions, and are separated from other symbols and used as hints by the conditional sub-expression analysis step/component.

In the following table, the rows are dominant symbols supported by the component, and the columns are the types of their relations with corresponding sub-expressions. The marks in cells of the table body mean dominant symbols may have the corresponding types of sub-expressions:

| | Above | Below | BondConnect_LT | BondConnect_RB |
|---|---|---|---|---|
| Condition line (=, →, | ✓ | ✓ | | |
| [symbol] ) | | | | |
| Single Bond | | | ✓ | ✓ |
| Double Bond | | | ✓ | ✓ |
| Triple Bond | | | ✓ | ✓ |

In this example, there are two cells are marked in the first row, whereby the condition line may have two sub-expressions, one above it and the other below it. For a chemical bond, there are two anchor points which may be connected to chemical atoms. In this example, the chemical bond has two control regions, and thus two relation points, BondConnect_LT and BondConnect_RB, as shown in FIG. 13.

To perform the organic atom determination and conditional sub-expression analysis, a graph search algorithm is used, including constructing a relation graph and search the top-N optimized spanning tree. In the graph, vertexes are symbols, and edges are possible relations between symbols and their corresponding intensity. It is also possible that there are multiple relations between two symbols due to spatial ambiguities.

In graph construction, relation scores are calculated for edges as a measure of intensity of a relation. Five relation types are taken into consideration, including the four relation types in the above table, and a horizontal relation enabled for any chemical symbol. Thus, for each couple of chemical symbols, there are five possible edges between them. Edges with a lower score than a specified threshold are removed in order to reduce memory cost and time cost.

For each symbol and for each enabled relation type, a rectangle centered control region is calculated from a fairly large training set. The control region is rectangle-centered, but it is infinite and truncated. In FIG. 7, the two rectangles represent the two rectangle centered control region for ‘BondConnect_LT and ‘BondConnect_RB’ relation types respectively.

Calculate point relation score to a control region refers to calculating the score to measure to how much extent a point (x, y) is subordinate to a specified control region according to sub-expression type R. If the point locates inside the centered rectangle of a control region, the score is set to 1.0, the largest possible score value. Conversely, if the point is not located in the control region, the according score is set to 0.0, the smallest score value. A general principle when calculating a relation score is that the nearer the point is to the centered rectangle, the larger the score. In one implementation, the equation used to calculate the score is:

$${f}_{R} ( x , y ) = \frac{1}{1 + {( \frac{\vert {o}_{R} ( x ) \vert}{{x}_{0}} )}^{{λ}_{x}}} \times \frac{1}{1 + {( \frac{\vert {o}_{R} ( y ) \vert}{{y}_{0}} )}^{{λ}_{y}}} .$$

where f_{R}(x, y) represents the score, and O_{R}(x), O_{R}(x) represents the offsets of the point (x, y) to the according rectangle respectively. λₓ, λ_{y}, x₀, y₀ are specified thresholds.

To calculate a symbol's relation score to a control region, given a symbol, a bounding box can be obtained. A specified large number of points in the bounding box are uniformly sampled, with point relation score calculated for each sampled point, one by one, using the above-described method. Those scores obtained at the second step are averaged to get the symbol relation score. In one implementation, the equation for calculating the score is:

$$\frac{1}{area of S} {\int \int }_{S} {f}_{R} ( x , y ) d x d y$$

where S is the bounding box of a symbol to calculate relation score, R is the according infinite but truncated control region and (x, y) is point in S.

Note that the graph is not a final description about the symbol relations. For example, there are many conflicts in the graph, one of which, as mentioned above, is that multiple relations may exist between two symbols, but actually only one is valid. Another example is when a symbol may be subordinate to multiple symbols in the graph.

Thus, after graph construction, a search process is performed in the graph to decide which relations are valid. These valid relations (edges) form an optimal spanning tree on the graph. Moreover, the search algorithm investigates almost all possible ways of combining the edges during the process. It can evaluate all combination ways, which are spanning trees, and record the Top-N optimal results. By finding sub-expressions for each dominant symbol, the Top-N hierarchical trees of sub-expression are constructed. These multiple results are mapped to the parse tree for further processing as described herein.

To decide the identities of dominant symbols, note that the symbol recognition component only supplies a list of character candidates for each symbol. Thus, the final symbols' character is still undetermined, because it is typically not possible to decide a unique character for each symbol only by symbol recognition; e.g., ‘Minus’ and “chemical single horizontal bond” cannot be distinguished from each other solely by a symbol recognizer. Structure context information is thus employed to distinguish candidates. For example, because the “chemical single horizontal bond” has two sub-expressions, the identities of such a dominant symbols may be determined via this structure information.

### Handwritten Inorganic Chemical Expression Recognition

The molecule in an expression is composed of chemical elements, and every chemical element has its own chemical valence, which is balanced for every molecule. Based on this point, a chemical valence analysis is performed, (as represented in FIG. 3 via component/step 312).

In chemistry, valence, also known as valency or valency number, is a measure of the number of chemical bonds formed by the atoms of a given element. In chemistry, a molecule is defined as a sufficiently stable electrically neutral group of at least two atoms in a definite arrangement held together by strong chemical bonds. In one system, the valence for each element is predefined, such as H (+1), O (−2), and so forth. Some chemical elements may contain several valences. For example, for element S, the valence may be +4 or +6. The valence for every molecule is computed, e.g., the valence of last molecule in FIG. 14 is: 1*2+6+(−2)*4=0. Also, if the molecule is not an ion, the valence should be equal to zero, otherwise the valence plus the ion number should be equal to zero.

Another way to validate chemical molecules is to look up it in a predefined chemical molecule database. If it is in the database, the molecule is considered as a validated one; otherwise it is an invalidated one. The molecule database consists of inorganic molecules and organic molecules.

As described above, chemical expressions may contain three kinds of condition symbols, =, → and [symbol] , as exemplified in FIGS. 5, 14 and 15, respectively. In a chemical expression, the condition symbols “=” and “ [symbol] ” mean the expression has been balanced, that is, the number and element type of the left reaction substances are equal to the right production substances. The condition symbol “→” means that the element type of the left reaction substances are equal to the right production substances.

Based upon the above, to help determine validity, if the condition symbol is “=” or “ [symbol] ”, then the system checks whether the number and element type of the left reaction substances are equal to the right production substances. If they are equal, the expression is valid, otherwise it is invalid.

If the condition symbol is “→”, then the system checks whether the element type of the left reaction substances are equal to the right production substances. If they are equal, the expression is valid, otherwise it is invalid.

Syntax analysis also may be performed by component/step 312 in order to make a recognized expression a semantic structure. To this end, text strings translated from sub-expressions are parsed by syntax analysis, and transformed into a syntax tree. This step/component 312 (FIG. 3) revises the parse tree according to the results of syntax analysis, and names the final parse tree as the semantic tree of the expression.

A semantic tree corresponds to the semantic structure of an expression. The component uses a context-free parser to do syntax analysis. The parser algorithm is a well-known technique, widely applied in the fields of language compiler, natural language processing, knowledge-based system and so forth. A library of grammar rules for chemical expressions is built and used; one such library includes more than 1,000 grammar rules, examples of which (rules related to condition structure) are set forth below:
CONDITIONLIST→CONDITIONSYMBOL
CONDITIONLIST→CONDITIONSYMBOL OVERSCRIPT
CONDITIONLIST→CONDITIONSYMBOL UNDERSCRIPT
CONDITIONLIST→CONDITIONSYMBOL OVERUNDERSCRIPT

In one example implementation, a system recognized more than 153 symbols including Chemical elements (H, Hi, Li, P, B, C, N etc.), Latin digits (1, 2, 3, 4, 5 etc.), Operators (+, −, etc.), Condition symbols (=, →, [symbol] ), and Frequently used chemical symbols (↑ ↓, %, ° C., etc.).

Turning to evaluation aspects, in order to evaluate the handwritten chemical recognition system, handwritten data was collected on paper and on a tablet-based computing device, and labeled manually. Labeling is time-consume and error prone, and thus a handwritten chemical equation labeling tool was developed. With the tool, when labeling the handwriting data, the user only needed to label the strokes of a corresponding symbol, which reduced the amount of time taken for data structure labeling and improved reliability.

To this end, a chemical equation template edit tool and chemical equation labeling tool were used. The chemical equation template edit tool is used to define the data structure of the chemical equation. The handwriting chemical equation's data structure includes stroke information, information that denotes the relationships between symbols, and the symbol information. An extended chemical markup language (ECML) was used as the format to store the handwriting chemical equation; in ECML, the data format for handwriting strokes, chemical symbols and chemical equation structure information is defined, with the chemical equation labeling tool used to label the chemical symbols.

In general, the chemical equation template edit tool is an application that enables a data collector to design the chemical equation templates. Two kinds of chemical equations can be designed, namely the organic and inorganic chemical equations. The tool saves the relationship between chemical structures without complicated manipulating. In one implementation, the tool is a WYSWYG (What You See What You Get) editor. The user uses a formula button to input the chemical formula at appointed position, and selects the basic radical structure of a chemical equation from a toolbar. Depending on the type of radical structure, the editor is responds differently. A molecule button inputs the inorganic compound including the count of the molecule and an additional string, which the editor translates into the corresponding ECML format. The compound button inputs the organic formulas, and the editor translates the drawing to the corresponding ECML format.

The chemical equation labeling tool is an application that collects the handwriting data and also labels the handwritten data via guided prompts. Before labeling, the user first opens an ECML file, and can write down the equation on a writing area. After completing the input strokes, the user can select the label button to label the strokes, which highlights the need to label the symbol; the user only needs to select the corresponding stokes, as the label tool highlights the next symbols automatically. After labeling the strokes, the chemical equation labeling tool can automatically save the labeled file and load the next ECML file.

### Exemplary Operating Environment

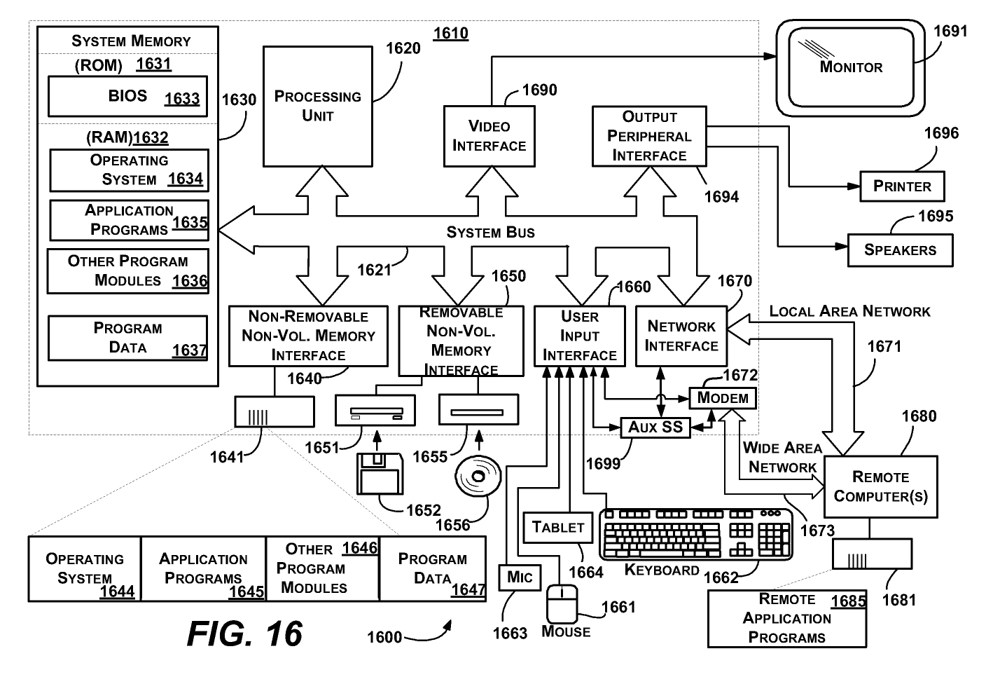

FIG. 16 illustrates an example of a suitable computing and networking environment 1600 on which the examples of FIGS. 1-15 may be implemented. The computing system environment 1600 is only one example of a suitable computing environment and is not intended to suggest any limitation as to the scope of use or functionality of the invention. Neither should the computing environment 1600 be interpreted as having any dependency or requirement relating to any one or combination of components illustrated in the exemplary operating environment 1600.

The invention is operational with numerous other general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 16, an exemplary system for implementing various aspects of the invention may include a general purpose computing device in the form of a computer 1610. Components of the computer 1610 may include, but are not limited to, a processing unit 1620, a system memory 1630, and a system bus 1621 that couples various system components including the system memory to the processing unit 1620. The system bus 1621 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 1610 typically includes a variety of computer-readable media. Computer-readable media can be any available media that can be accessed by the computer 1610 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 1610. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media.

The system memory 1630 includes computer storage media in the form of volatile and/or nonvolatile memory such as read only memory (ROM) 1631 and random access memory (RAM) 1632. A basic input/output system 1633 (BIOS), containing the basic routines that help to transfer information between elements within computer 1610, such as during start-up, is typically stored in ROM 1631. RAM 1632 typically contains data and/or program modules that are immediately accessible to and/or presently being operated on by processing unit 1620. By way of example, and not limitation, FIG. 16 illustrates operating system 1634, application programs 1635, other program modules 1636 and program data 1637.

The computer 1610 may also include other removable/non-removable, volatile/nonvolatile computer storage media. By way of example only, FIG. 16 illustrates a hard disk drive 1641 that reads from or writes to non-removable, nonvolatile magnetic media, a magnetic disk drive 1651 that reads from or writes to a removable, nonvolatile magnetic disk 1652, and an optical disk drive 1655 that reads from or writes to a removable, nonvolatile optical disk 1656 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 1641 is typically connected to the system bus 1621 through a non-removable memory interface such as interface 1640, and magnetic disk drive 1651 and optical disk drive 1655 are typically connected to the system bus 1621 by a removable memory interface, such as interface 1650.

The drives and their associated computer storage media, described above and illustrated in FIG. 16, provide storage of computer-readable instructions, data structures, program modules and other data for the computer 1610. In FIG. 16, for example, hard disk drive 1641 is illustrated as storing operating system 1644, application programs 1645, other program modules 1646 and program data 1647. Note that these components can either be the same as or different from operating system 1634, application programs 1635, other program modules 1636, and program data 1637. Operating system 1644, application programs 1645, other program modules 1646, and program data 1647 are given different numbers herein to illustrate that, at a minimum, they are different copies. A user may enter commands and information into the computer 1610 through input devices such as a tablet, or electronic digitizer, 1664, a microphone 1663, a keyboard 1662 and pointing device 1661, commonly referred to as mouse, trackball or touch pad. Other input devices not shown in FIG. 16 may include a joystick, game pad, satellite dish, scanner, or the like. These and other input devices are often connected to the processing unit 1620 through a user input interface 1660 that is coupled to the system bus, but may be connected by other interface and bus structures, such as a parallel port, game port or a universal serial bus (USB). A monitor 1691 or other type of display device is also connected to the system bus 1621 via an interface, such as a video interface 1690. The monitor 1691 may also be integrated with a touch-screen panel or the like. Note that the monitor and/or touch screen panel can be physically coupled to a housing in which the computing device 1610 is incorporated, such as in a tablet-type personal computer. In addition, computers such as the computing device 1610 may also include other peripheral output devices such as speakers 1695 and printer 1696, which may be connected through an output peripheral interface 1694 or the like.

The computer 1610 may operate in a networked environment using logical connections to one or more remote computers, such as a remote computer 1680. The remote computer 1680 may be a personal computer, a server, a router, a network PC, a peer device or other common network node, and typically includes many or all of the elements described above relative to the computer 1610, although only a memory storage device 1681 has been illustrated in FIG. 16. The logical connections depicted in FIG. 16 include one or more local area networks (LAN) 1671 and one or more wide area networks (WAN) 1673, but may also include other networks. Such networking environments are commonplace in offices, enterprise-wide computer networks, intranets and the Internet.

When used in a LAN networking environment, the computer 1610 is connected to the LAN 1671 through a network interface or adapter 1670. When used in a WAN networking environment, the computer 1610 typically includes a modem 1672 or other means for establishing communications over the WAN 1673, such as the Internet. The modem 1672, which may be internal or external, may be connected to the system bus 1621 via the user input interface 1660 or other appropriate mechanism. A wireless networking component 1674 such as comprising an interface and antenna may be coupled through a suitable device such as an access point or peer computer to a WAN or LAN. In a networked environment, program modules depicted relative to the computer 1610, or portions thereof, may be stored in the remote memory storage device. By way of example, and not limitation, FIG. 16 illustrates remote application programs 1685 as residing on memory device 1681. It may be appreciated that the network connections shown are exemplary and other means of establishing a communications link between the computers may be used.

An auxiliary subsystem 1699 (e.g., for auxiliary display of content) may be connected via the user interface 1660 to allow data such as program content, system status and event notifications to be provided to the user, even if the main portions of the computer system are in a low power state. The auxiliary subsystem 1699 may be connected to the modem 1672 and/or network interface 1670 to allow communication between these systems while the main processing unit 1620 is in a low power state.

### Conclusion

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. In a computing environment, a method comprising, receiving electronic input corresponding to handwritten input with a two-dimensional structure, performing stroke segmentation and symbol recognition on the input, analyzing the two-dimensional structure of the input, and outputting a data structure corresponding to recognition results of the handwritten input.

2. The method of claim 1 wherein analyzing the two-dimensional structure of the input comprises performing a conditional sub-expression analysis.

3. The method of claim 1 wherein analyzing the two-dimensional structure of the input comprises performing a subscript, superscript analysis and a character determination analysis.

4. The method of claim 1 wherein the handwritten input includes an organic chemical expression, and wherein analyzing the two-dimensional structure of the input comprises performing a bond detection and connection relationship analysis, or performing atom determination, or performing both a bond detection and connection relationship analysis and performing atom determination.

5. The method of claim 1 further comprising, performing a semantic structure analysis.

6. The method of claim 5 wherein the handwritten input corresponds to a chemical expression, and wherein performing the semantic structure analysis comprises performing a chemical valence analysis.

7. The method of claim 5 wherein performing the semantic structure analysis comprises performing a syntax analysis with a syntax tree.

8. The method of claim 1 wherein outputting the data structure comprises outputting an extended baseline structure tree.

9. The method of claim 8 wherein outputting the extended baseline structure tree comprises including at least one solution node representing multiple recognition results.

10. The method of claim 9 wherein outputting the data structure comprises outputting a baseline structure tree having stroke nodes representing strokes, symbol nodes representing symbols, BST symbol nodes representing a compound of a dominant symbol and its sub-baselines and relation nodes representing a baseline.

11. The method of claim 1 wherein the handwritten input corresponds to a chemical expression, and further comprising, providing a chemical equation template edit tool and a chemical equation labeling tool for receiving sample handwritten chemical expressions.

12. In a computing environment, a system comprising, a handwriting recognition framework, including two-dimensional structure analysis logic that receives a data structure comprising stroke and symbol data from a recognizer, processes the data structure based on a structure of the expression, and provides the modified data structure to one or more further analysis components which further modifies the data structure into output.

13. The system of claim 12 wherein the data structure comprises a baseline structure tree having stroke nodes representing strokes, symbol nodes representing symbols, BST symbol nodes representing a compound of a dominant symbol and its sub-baselines and relation nodes representing a baseline.

14. The system of claim 13 wherein multiple candidates are recognized, and wherein the framework modifies the baseline structure tree into an extended baseline structure tree by including solution nodes, each solution node corresponding to a recognition candidate.

15. The system of claim 12 wherein the structure analysis logic performs subscript, superscript analysis and character determination.

16. The system of claim 12 wherein the structure analysis logic performs conditional sub-expression analysis to find any sub-expression for each conditional symbol recognized from the handwritten input.

17. The system of claim 12 wherein the one or more further analysis components a semantic structure analysis component, including chemical valence analysis component or a syntax analysis component, or both a chemical valence analysis component and a syntax analysis component.

18. The system of claim 12 wherein the data to be analyzed comprises a chemical expression including an organic bond, and wherein the structure analysis logic performs organic bond detection, or a connection relationship analysis, or an atom determination, or any combination of a connection relationship analysis, organic atom determination, or conditional sub-expression analysis.

19. One or more computer-readable media having computer-executable instructions, which when executed perform steps, comprising:
processing input ink into stroke data and symbol data in a data structure;
modifying the data structure based upon a structural analysis of the stroke data and symbol data, including:
a) determining whether data to be analyzed corresponds to an organic bond, and if so,
i) performing organic bond detection, or connection relationship analysis, or organic atom determination, or conditional sub-expression analysis, or any combination of organic bond detection, connection relationship analysis, organic atom determination, or conditional sub-expression analysis, and if not,
ii) performing conditional sub-expression analysis;
b) performing subscript, superscript analysis and character determination; and
performing at least one other analysis that further modifies the data structure, including a chemical valence analysis or a syntax analysis, or both a chemical valence analysis and a syntax analysis.

20. The one or more computer-readable media of claim 19 having further computer-executable instructions comprising extending the data structure by including solution nodes therein, each solution node corresponding to a recognition candidate.
